(19) United States
(12) Patent Application Publication
(10) Pub. No.: US 2023/0278426 A1
(43) Pub. Date: Sep. 7, 2023

(54) VEHICLE-MOUNTED APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Shinsuke TSUDA, Yokohama-shi Kanagawa-ken (JP); Satoru SASAKI, Gotenba-shi Sizuoka-ken (JP); Ko KOGA, Setagaya-ku Tokyo-to (JP); Kimi SUGAWARA, Itabashi-ku Tokyo-to (JP)

(73) Assignee: TOYOTA JIDOSHA KABUSHIKI KAISHA, Toyota-shi Aichi-ken (JP)

(21) Appl. No.: 18/115,311

(22) Filed: Feb. 28, 2023

(30) Foreign Application Priority Data
Mar. 1, 2022 (JP) 2022-030605

(51) Int. Cl. B60K 35/00

(52) U.S. Cl. CPC B60K 35/00; B60K 2370/148; B60K 2370/736; B60K 2370/175; B60K 2370/589; B60K 2370/152

(57) ABSTRACT

A vehicle-mounted apparatus according to one aspect of the present disclosure receives an utterance-based inquiry of a passenger in a vehicle, and identifies the passenger that is an utterer of the received inquiry. The vehicle-mounted apparatus selects, in accordance with a result of the identification of the passenger, an output device serving as a destination to which a response to the inquiry is to be output. Then, the vehicle-mounted apparatus outputs the response to the inquiry to the selected output device.

### CROSS REFERENCE TO THE RELATED APPLICATION

This application claims the benefit of Japanese Patent Application No. 2022-030605, filed on Mar. 1, 2022, which is hereby incorporated by reference herein in its entirety.

### BACKGROUND

### Technical Field

The present disclosure relates to a vehicle-mounted apparatus, an information processing method, and a non-transitory storage medium.

### Description of the Related Art

A navigation apparatus configured to output information on an object in accordance with directions from a driver is proposed in Patent Literature 1. Specifically, the navigation apparatus proposed in Patent Literature 1 stores information on an object in association with the position where the object is present. The navigation apparatus detects the position of a vehicle in accordance with utterance-based directions from a driver and extracts information on an object corresponding to the detected position of the vehicle. At this time, the navigation apparatus obtains a picked-up image from a first camera that is arranged so as to face toward the front of the vehicle, and identifies the object appearing in the obtained picked-up image. The navigation apparatus also obtains a picked-up image from a second camera that is arranged so as to pick up an image of the eyes of the driver, calculates the direction of the driver's gaze from the obtained picked-up image, and identifies an object present in the calculated direction of the driver's gaze. Then, the navigation apparatus checks the objects identified by the respective methods against each other, and gives notification of information on the matching objects.

### CITATION LIST

### Patent Literature

Patent Literature 1: Japanese Patent Laid-Open No. 2001-330450

### SUMMARY

It is an object of the present disclosure to provide a technique for enhancing accessibility to a response to an inquiry from a passenger.

A vehicle-mounted apparatus according to a first aspect of the present disclosure may include a controller configured to execute receiving an utterance-based inquiry of a passenger in a vehicle, identifying the passenger that is an utterer of the received inquiry, selecting, in accordance with a result of the identification of the passenger, an output device serving as a destination to which a response to the inquiry is to be output, and outputting the response to the inquiry to the selected output device.

An information processing method according to a second aspect of the present disclosure is an information processing method to be executed by a computer, and may include receiving an utterance-based inquiry of a passenger in a vehicle, identifying the passenger that is an utterer of the received inquiry, selecting, in accordance with a result of the identification of the passenger, an output device serving as a destination to which a response to the inquiry is to be output, and outputting the response to the inquiry to the selected output device.

A non-transitory storage medium according to a third aspect of the present disclosure is a non-transitory storage medium storing a program for causing a computer to execute an information processing method, and the information processing method may include receiving an utterance-based inquiry of a passenger in a vehicle, identifying the passenger that is an utterer of the received inquiry, selecting, in accordance with a result of the identification of the passenger, an output device serving as a destination to which a response to the inquiry is to be output, and outputting the response to the inquiry to the selected output device.

According to the present disclosure, it is possible to enhance accessibility to a response to an inquiry from a passenger.

### BRIEF DESCRIPTION OF THE DRAWINGS

FIG. 1 schematically illustrates an example of a situation to which the present disclosure is applied;

FIG. 2 schematically illustrates an example of a hardware configuration of a vehicle-mounted apparatus according to an embodiment;

FIG. 3 schematically illustrates an example of a software configuration of the vehicle-mounted apparatus according to the embodiment; and

FIG. 4 is a flowchart illustrating an example of a processing procedure of the vehicle-mounted apparatus according to the embodiment.

### DESCRIPTION OF THE EMBODIMENTS

The navigation apparatus proposed in the above Patent Literature 1 can provide, to a driver, information on an object that is present in front of a vehicle and at which the driver is gazing in response to an utterance-based inquiry. However, a passenger that makes an utterance-based inquiry in the vehicle is not limited to the driver. For example, when the vehicle is a common automobile, a fellow passenger can be present as a passenger, in addition to the driver. When a response to an inquiry from the fellow passenger is output by the same output device as the driver, accessibility to the response may decrease.

Assume, as an example, a case where a response to an inquiry from the fellow passenger is output to a vehicle-mounted display for the driver when the fellow passenger is sitting in a seat behind the driver's seat. In this case, the vehicle-mounted display for the driver is not always arranged at a place where the vehicle-mounted display is easily viewable by the fellow passenger. When the vehicle-mounted display is arranged at a place where the vehicle-mounted display is hard for the fellow passenger to view, checking a response output to the vehicle-mounted display takes the fellow passenger some time.

To cope with the above-described problem, the vehicle-mounted apparatus according to the first aspect of the present disclosure may include a controller configured to execute receiving an utterance-based inquiry of a passenger in a vehicle, identifying the passenger that is an utterer of the received inquiry, selecting, in accordance with a result of the identification of the passenger, an output device serving as a destination to which a response to the inquiry is to be output, and outputting the response to the inquiry to the selected output device.

In the vehicle-mounted apparatus according to the first aspect of the present disclosure, a passenger that has made an utterance-based inquiry may be identified, and an output device as an output destination of a response may be selected in accordance with a result of the identification. Accordingly, it is possible to output a response to a suitable output device for each passenger (driver/fellow passenger) by controlling the output destination of the response for the passenger. Thus, the vehicle-mounted apparatus according to the first aspect of the present disclosure can enhance accessibility to a response to an inquiry from a passenger.

An embodiment according to an aspect of the present disclosure (hereinafter also referred to as the “present embodiment”) will be described with reference to the drawings. Note that the present embodiment to be described below is merely illustrative of the present disclosure in all respects. Various improvements or modifications may be made without departing from the scope of the present disclosure. In implementing the present disclosure, a specific configuration appropriate to an embodiment may be properly adopted. Note that although data appearing in the present embodiment is described in a natural language, the data is designated by a pseudo-language, a command, a parameter, a machine language, or the like, which is computer-recognizable, to be more specific.

### 1 Application Example

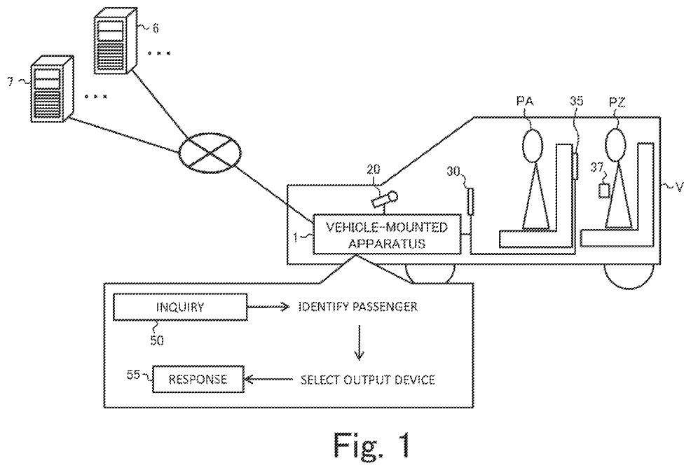

FIG. 1 schematically illustrates an example of a situation to which the present disclosure is applied. A vehicle-mounted apparatus 1 according to the present embodiment is one or more computers which are configured to execute an information process for outputting a response to an utterance-based inquiry from a passenger in a vehicle V.

Specifically, the vehicle-mounted apparatus 1 according to the present embodiment receives an utterance-based inquiry 50 of a passenger in the vehicle V and identifies the passenger (hereinafter also referred to as an “utterer”) that has uttered the received inquiry 50. The vehicle-mounted apparatus 1 selects, in accordance with a result of the identification of the passenger, an output device serving as a destination to which a response 55 to the inquiry 50 is to be output. The vehicle-mounted apparatus 1 outputs the response 55 to the inquiry 50 to the selected output device.

As described above, the vehicle-mounted apparatus 1 according to the present embodiment can output the response 55 to a suitable output device for each passenger by controlling an output destination of the response 55 to the inquiry 50 in accordance with a result of identification of an utterer. This allows enhancement of accessibility to the response 55 to the inquiry 50 from a passenger.

(Vehicle)

The type of the vehicle V is not particularly limited as long as a plurality of passengers can get in the vehicle V, and may be properly selected in accordance with an embodiment. In a typical example, the vehicle V may be an automobile. The vehicle V may be an automobile configured to run by manual driving or an automobile configured to be capable of running at least partially by automated driving.

(Passenger)

A passenger is a driver PA or a fellow passenger PZ. The driver PA is a passenger that sits in a driver's seat and performs handling for driving of the vehicle V. The fellow passenger PZ is a passenger that sits in a seat other than the driver's seat and is a passenger other than the driver PA. The number of and seats for fellow passengers PZ need not be particularly limited and may be properly selected in accordance with an embodiment, operation, or the like.

In the example in FIG. 1, seats of the vehicle V are arranged in two rows, and one fellow passenger PZ is sitting in a seat behind the driver's seat (in the second row). A plurality of seats may be provided in the second row, and the fellow passenger PZ may be sitting in any of the plurality of seats. Note that the number of and seats for fellow passengers PZ need not be limited to the example. In another example, a plurality of fellow passengers PZ may be in the vehicle V. The fellow passenger PZ may be sitting in a seat (e.g., a fellow passenger seat) juxtaposed to the driver's seat. The seats of the vehicle V may be arranged in one row. Alternatively, the seats of the vehicle V may be arranged in three or more rows, and the fellow passenger PZ may be sitting in any seat in any row.

(Utterer Identification Method)

A method for identifying a passenger that has made an utterance need not be particularly limited and may be properly selected in accordance with an embodiment. A publicly known method may be adopted as the utterer identification method.

In one example, the vehicle-mounted apparatus 1 may be configured to observe an utterance-based inquiry of a passenger with a microphone 20. The microphone 20 may be configured to have directivity. The vehicle-mounted apparatus 1 may be correspondingly configured to identify an utterer on the basis of a sound collection direction of an utterance observed by the microphone 20.

The microphone 20 may be properly arranged so as to be capable of observing an utterance of a passenger. The microphone 20 may be provided as a part of the vehicle-mounted apparatus 1. Alternatively, the microphone 20 may be provided independently of the vehicle-mounted apparatus 1. For example, the microphone 20 may be provided in a different computer that is a separate apparatus from the vehicle-mounted apparatus 1.

Note that the utterer identification method need not be limited to the above-described examples. In another example, the vehicle V may include a vehicle-mounted camera that is arranged so as to pick up an image of an in-vehicle condition. The vehicle-mounted apparatus 1 may identify an utterer by analyzing a picked-up image obtained by the vehicle-mounted camera at a timing of an utterance of the inquiry 50.

(Identifying)

In one example, identifying an utterer may refer to simply identifying whether the utterer is a driver PA or a fellow passenger PZ (hereinafter also referred to as “simple identification”) and need not include identifying individuality of the utterer (hereinafter also referred to as “individuality identification”). In another example, identifying an utterer may include both simple identification and individuality identification of the utterer. Note that, in one example, simply identifying an utterer may be identifying which of passengers the utterer is and in which seat the passenger is sitting.

When identifying an utterer includes identifying individuality of the utterer, a simple identification method and an individuality identification method may be the same or different. When an utterer is simply identified on the basis of a sound collection direction as described above in one example, the vehicle-mounted apparatus 1 may analyze a voiceprint in voice data of an utterance and identify individuality of the utterer on the basis of a result of analyzing the voiceprint. In another example, the vehicle-mounted apparatus 1 may simply identify an utterer through image analysis on a picked-up image obtained by a vehicle-mounted camera and identify individuality of the utterer by a method, such as facial image recognition. In still another example, the vehicle-mounted apparatus 1 may be configured to simply identify an utterer by the sound collection direction-based method and identify individuality of the utterer by the image analysis-based method.

A method for identifying individuality of an utterer may be the same for both a driver PA and a fellow passenger PZ. Alternatively, the method for identifying individuality of an utterer may be different between the driver PA and the fellow passenger PZ. In one example, either one of the voiceprint recognition-based method and the facial image recognition-based method may be adopted as a method for identifying individuality of the fellow passenger PZ. In contrast, the vehicle-mounted apparatus 1 may identify individuality of the driver PA by a different method, such as a method based on information included in an electronic key (smart key) or biometric (e.g., fingerprint) authentication.

(Selection of Output Device)

Selecting an output device in accordance with a result of identification of an utterer may be composed of selecting an output device for a driver PA as an output destination when the utterer is identified as the driver PA and selecting an output device for a fellow passenger PZ as the output destination when the utterer is identified as the fellow passenger PZ. An output device for each passenger (the driver PA or the fellow passenger PZ) may be properly selected in accordance with an embodiment.

In one example, the output device for the driver PA may be a vehicle-mounted display 30 that is arranged for the driver PA (the driver's seat). That is, selecting an output device in accordance with a result of identification may include selecting the vehicle-mounted display 30 arranged for the driver PA as an output device serving as a destination to which the response 55 is to be output when a passenger that has uttered the inquiry 50 is the driver PA. This allows proper provision of the response 55 to the inquiry 50 to the driver PA.

Note that the vehicle-mounted display 30 may be arranged at an arbitrary place around the driver's seat so as to be easily viewable by the driver PA. In one example, the vehicle-mounted display 30 may be arranged at or near a center cluster. In another example, the vehicle-mounted display 30 may be a head-up display which projects information onto a part of a windshield.

The vehicle-mounted display 30 may be provided as a part of the vehicle-mounted apparatus 1. Alternatively, the vehicle-mounted display 30 may be provided independently of the vehicle-mounted apparatus 1. For example, the vehicle-mounted display 30 may be provided in a different computer that is a separate apparatus from the vehicle-mounted apparatus 1. For example, a display of a mobile terminal, such as a cellular phone which may be a smartphone or a tablet PC (personal computer), of the driver PA may be used as the vehicle-mounted display 30.

In one example, the output device for the fellow passenger PZ may be a vehicle-mounted display 35 that is arranged for a seat for the fellow passenger PZ or a terminal 37 of the fellow passenger PZ. That is, selecting an output device in accordance with a result of identification may include selecting the vehicle-mounted display 35 or the terminal 37 of the fellow passenger PZ as an output device serving as a destination to which the response 55 is to be output when a passenger that has uttered the inquiry 50 is the fellow passenger PZ. This allows proper provision of the response 55 to the inquiry 50 to the fellow passenger PZ.

Note that the vehicle-mounted display 35 may be arranged at an arbitrary place around the seat for the fellow passenger PZ so as to be easily viewable by the fellow passenger PZ. In one example, the vehicle-mounted display 35 may be arranged near a fellow passenger seat under the assumption that the fellow passenger PZ sits in the fellow passenger seat. In this case, the vehicle-mounted display 35 may be provided specifically for the fellow passenger PZ. Alternatively, the vehicle-mounted display 30 for the driver PA may double as the vehicle-mounted display 35 for the fellow passenger PZ. The vehicle-mounted display 35 may be arranged on the back of a seat in front of the seat for the fellow passenger PZ under the assumption that the fellow passenger PZ sits in a seat behind the driver's seat (in the second row or a subsequent row). A plurality of vehicle-mounted displays 35 may be provided in the vehicle V so as to correspond to a plurality of fellow passengers PZ which are to get in. The terminal 37 may be, for example, a mobile terminal of the fellow passenger PZ, such as a cellular phone which may be a smartphone or a tablet PC.

(Output Timing)

The vehicle-mounted apparatus 1 may output the response 55 at an arbitrary timing after reception of the inquiry 50.

In one example, when an utterer is a fellow passenger PZ, the vehicle-mounted apparatus 1 may execute an output process for outputting the response 55 promptly after reception of the inquiry 50. On the other hand, when the utterer is a driver PA, the vehicle-mounted apparatus 1 may control a timing for the output process so as to output the response 55 while manual running of the vehicle V by the driver PA is not being performed after the reception of the inquiry 50.

That is, the vehicle-mounted apparatus 1 (a controller) may be configured to further execute judging whether or not manual running of the vehicle V is being performed when a passenger that has uttered the inquiry 50 is the driver PA. When the passenger that has uttered the inquiry 50 is the driver PA, outputting the response 55 to the inquiry 50 may be executed after it is judged that manual running of the vehicle V is not being performed.

In a typical example, a timing when manual running of the vehicle V is not being performed may be a timing when running of the vehicle V is halted, such as a brief stop, a wait for a traffic light, or completion of running (parking). When the vehicle V is configured to be capable of running by automated driving, timings when manual running of the vehicle V is not being performed may include a timing when the vehicle V is running by automated driving.

The vehicle-mounted apparatus 1 may properly observe an working condition (e.g., whether or not the vehicle V is running, the on/off state of automated driving, and the like) of the vehicle V with a vehicle-mounted sensor. As the vehicle-mounted sensor, for example, a publicly known sensor, such as a speedometer, an accelerator sensor, or a steering sensor, may be used. The vehicle-mounted apparatus 1 may judge, on the basis of a result of observing the working condition of the vehicle V with the vehicle-mounted sensor, whether or not manual running of the vehicle V is being performed. The control of the output process allows provision of the response 55 to the driver PA at a timing when content of the response 55 is easily checkable.

Note that, depending on the type of the inquiry 50, when a period from the inquiry 50 to a timing when the response 55 is output is too long, the response 55 may be already unnecessary for the driver PA at the output timing. An example of this case is a case where the inquiry 50 is about a facility present in surroundings of the vehicle V and the driver PA desires to immediately obtain facility information about the facility at a point where the inquiry 50 has been made.

For the above-described reason, in one example, the vehicle-mounted apparatus 1 may monitor an elapsed time period since reception of the inquiry 50. The elapsed time period may be monitored by an arbitrary method. The vehicle-mounted apparatus 1 may judge whether or not the elapsed time period has exceeded a predetermined threshold. When the elapsed time period has exceeded the predetermined threshold, the vehicle-mounted apparatus 1 may discard the response 55 to the inquiry 50 and skip execution of the process of outputting the response 55.

In another example, the vehicle-mounted apparatus 1 may monitor a running distance of the vehicle V after reception of the inquiry 50 instead of or in addition to the elapsed time period. The running distance may be monitored by an arbitrary method. The vehicle-mounted apparatus 1 may judge whether or not the running distance has exceeded a predetermined threshold instead of or in addition to judgment of the elapsed time period. When the running distance has exceeded the predetermined threshold, the vehicle-mounted apparatus 1 may discard the response 55 to the inquiry 50 and skip execution of the process of outputting the response 55.

Note that the response 55 need not be immediately discarded in either method. For example, the vehicle-mounted apparatus 1 may accept selection as to whether or not to discard the response 55 to the inquiry 50 when at least one of the elapsed time period and the running distance has exceeded the predetermined threshold. The vehicle-mounted apparatus 1 may discard the response 55 in accordance with selection of intent to agree on discard.

Note that a timing to output the response 55 is not limited to the above-described examples. In another example, the vehicle-mounted apparatus 1 may execute the output process for promptly outputting the response 55 regardless of the working condition of the vehicle V after reception of the inquiry 50 both in a case where an utterer is the driver PA and in a case where the utterer is the fellow passenger PZ.

The vehicle-mounted apparatus 1 may be configured to output the response 55 by a plurality of output methods. In this case, output timings of the response 55 by the respective output methods may be the same or at least some of the timings may be different. In one example, an output device for each passenger further includes a speaker (which may be earphones, headphones, or the like), the response 55 may be output both by voice and through screen display. In this case, a timing for voice output may be the same as or different from a timing for screen output. When an utterer is the fellow passenger PZ, the vehicle-mounted apparatus 1 may promptly output the response 55 by voice and through screen display after reception of the inquiry 50. On the other hand, when the utterer is the driver PA, the vehicle-mounted apparatus 1 may promptly output the response 55 by voice after reception of the inquiry 50. The vehicle-mounted apparatus 1 may output the response 55 through screen display after judgment that manual running of the vehicle V is not being performed.

(Inquiry/Response)

Inquiries 50 may include every type of inquiry that can be made while a passenger is in the vehicle V. The inquiry 50 may be, for example, a request for an information search, a request for an information process, or the like. The response 55 may be properly generated in response to the inquiry 50.

The response 55 may be generated by an arbitrary information process. A publicly known method may be adopted as a method for generating the response 55. At least a part of a process of generating the response 55 may be executed by a different computer. A trained machine learning model that is generated by machine learning may be used to generate the response 55.

The machine learning model includes one or more computation parameters for executing computation in an inference process. In this case, the inference process may be generating a response to a given inquiry. The type of the machine learning model need not be particularly limited and may be properly selected in accordance with an embodiment. The machine learning model may be, for example, a neural network, or the like. When a neural network is adopted, a weight for coupling between nodes, a threshold for each node, and the like are examples of the computation parameters.

The machine learning model may be properly trained by machine learning so as to acquire the capability to generate a response to a given inquiry. In a machine learning process, a value of a computation parameter of the machine learning model may be adjusted (optimized) so as to acquire the capability to generate a proper response to a given inquiry. A data format for an inquiry to be input to the machine learning model need not be particularly limited and may be properly selected in accordance with an embodiment. The inquiry may be composed of, for example, voice data, text data, or the like. The machine learning model may be configured to, for example, accept input of information other than an inquiry, such as position information or attribute information of a passenger.

Arbitrary information may be used to construct the response 55. Information from which the response 55 is constructed may be managed on a database. The information, from which the response 55 is constructed, may be held in an arbitrary storage region. In one example, the information, from which the response 55 is constructed, may be held in the vehicle-mounted apparatus 1. In another example, the information, from which the response 55 is constructed, may be held in a different computer (e.g., an external server 6). In this case, the vehicle-mounted apparatus 1 may obtain the information from the different computer, generate the response 55 from the obtained information, and output the generated response 55 to an output device. Alternatively, the vehicle-mounted apparatus 1 may cause the different computer to generate the response 55 and transmit the generated response 55 to the output device.

For example, the inquiry 50 may be about a facility present in the surroundings of the vehicle V. The response 55 may be constructed from facility information about a facility present in the surroundings of the vehicle V at the time of the inquiry 50. The facility information is an example of the information described above, from which the response 55 is constructed. The facility information may be POI (Point of Interest) information. The facility information may include, for example, a list of facilities, facility attribute information (e.g., location, type, phone number, and business hours), or the like. This allows enhancement of accessibility to the response 55 to the inquiry 50 from a passenger in a situation where facility information is provided.

In one example, the vehicle-mounted apparatus 1 may identify the content of the inquiry 50 by executing voice analysis on voice data of an utterance. When the inquiry 50 is identified as being about a facility present in the surroundings of the vehicle V, the vehicle-mounted apparatus 1 may obtain position information of the vehicle V. The position information may be obtained by an arbitrary method. For example, the vehicle V or the vehicle-mounted apparatus 1 may include a GPS (Global Positioning System) instrument, and the vehicle-mounted apparatus 1 may obtain the position information of the vehicle V from the GPS instrument. The vehicle-mounted apparatus 1 may obtain facility information about a facility present in the surroundings of the vehicle V on the basis of the position of the vehicle V indicated by the position information and construct the response 55 from the obtained facility information.

The vehicle-mounted apparatus 1 may cause a different computer to execute at least a part of the process of generating the response 55. At least a part of the process of generating the response 55 may be executed as a computation process of a trained machine learning model. In one example, the machine learning model may be trained by machine learning so as to acquire the capability to accept input of an inquiry and position information and generate a proper response in response to the input inquiry and position information. The vehicle-mounted apparatus 1 or the different computer may use the trained machine learning model to generate the response 55 that is constructed from facility information about a facility present in the surroundings of the vehicle V at the time of the inquiry 50.

A criterion for distances at which a facility is judged to be in the surroundings of the vehicle V need not be particularly limited and may be properly determined in accordance with an embodiment. Facility information about an arbitrary facility may be associated with a geographical position of the facility and be managed on a database.

In one example, a database on facility information may be held in the vehicle-mounted apparatus 1. In this case, the vehicle-mounted apparatus 1 may refer to the database held in memory resources and generate the response 55 to the inquiry 50. The vehicle-mounted apparatus 1 may output the generated response 55 to an output device.

In another example, the database on facility information may be held in the external server 6. In this case, outputting the response 55 to the inquiry 50 may be composed of obtaining facility information from the external server 6 and outputting the obtained facility information to an output device or causing the external server 6 to transmit the facility information to the output device. The vehicle-mounted apparatus 1 may be configured to be capable of connecting to the external server 6 via a network. The network may be properly selected from among, for example, the Internet, a wireless communication network, a mobile communications network, a telephone network, a dedicated network, and the like. The external server 6 may be composed of one or more server apparatuses. With this configuration, consumption of the memory resources of the vehicle-mounted apparatus 1 can be reduced as compared with a case where the database on facility information is held in the vehicle-mounted apparatus 1. It is thus possible to curb manufacturing costs of the vehicle-mounted apparatus 1.

(Output Method)

A path through which the response 55 is output to an output device need not be particularly limited and may be properly selected in accordance with an embodiment.

In one example, at least either of the vehicle-mounted displays (30 and 35) and the terminal 37 of a fellow passenger PZ may be connected to a network. In a typical example, the terminal 37 among the vehicle-mounted displays and the terminal 37 may be connected to the network. The vehicle-mounted apparatus 1 may also be correspondingly connected to the network. In this case, the vehicle-mounted apparatus 1 may output (transmit) the response 55 to an output device via the network. Alternatively, the vehicle-mounted apparatus 1 may cause a different computer (e.g., the external server 6 described above) to execute the process of transmitting the response 55 to the output device.

Note that information indicating a transmission destination of an output device may be obtained by an arbitrary method. The information indicating the transmission destination may be, for example, a telephone number, an e-mail address, or the like. The information indicating the transmission destination may be managed as profile information associated with information (e.g., an ID) for identification of a passenger. In one example, the vehicle-mounted apparatus 1 may identify individuality of an utterer in the process of identifying the utterer, as described above. The vehicle-mounted apparatus 1 may obtain profile information of the utterer in accordance with a result of identifying the individuality of the utterer. The vehicle-mounted apparatus 1 may identify a transmission destination of an output device by referring to the obtained profile information. The vehicle-mounted apparatus 1 may transmit the response 55 to the identified transmission destination. To cause the different computer to transmit the response 55, the vehicle-mounted apparatus 1 may also cause the different computer to execute the process of obtaining profile information. In this manner, the vehicle-mounted apparatus 1 may output the response 55 to an output device for an utterer.

Further, at least either of the vehicle-mounted displays (30 and 35) and the terminal 37 of the fellow passenger PZ may be directly connected to the vehicle-mounted apparatus 1, either wired or wirelessly. In a typical example, the vehicle-mounted displays (30 and 35) among the vehicle-mounted displays and the terminal 37 may be directly connected to the vehicle-mounted apparatus 1 by wire or by radio. For example, a publicly known method, such as Wi-Fi® or Bluetooth®, may be adopted as a connection method based on wireless communication. In this case, the vehicle-mounted apparatus 1 may directly output the generated response 55 to an output device. Alternatively, when the output device is configured to be capable of connecting to a network, the vehicle-mounted apparatus 1 may output the response 55 to the output device by the same method as described above.

(Output Suited to Attribute)

In one example, the response 55 may be optimized in accordance with an attribute of an utterer. Optimizing the response 55 may be composed of, for example, extracting information suited to an attribute from pieces of information applicable to the response 55, determining an information output order to be an order of decreasing the degree to which information is suited to an attribute, or a combination thereof. In a specific example, in a case where the response 55 is constructed from facility information as described above, the facility information may be about a facility suited to an attribute of a passenger that has uttered the inquiry 50 among a plurality of facilities present in the surroundings of the vehicle V at the time of the inquiry 50. As the optimization method, for example, a publicly known method, such as collaborative filtering, may be adopted.

The types and the number of attributes of a passenger need not be particularly limited as long as the attributes can be used to optimize the response 55 and may be properly determined in accordance with an embodiment. The attributes of the passenger may include, for example, age, hobbies/preferences, a history of facilities visited in the past, a history of pieces of information searched for in the past, and the like. In the above-described specific example, the vehicle-mounted apparatus 1 may extract, as a facility suited to the attribute of the utterer, a facility suited to hobbies or preferences of the utterer among the plurality of facilities present in the surroundings of the vehicle V at the time of the inquiry 50. The vehicle-mounted apparatus 1 may output facility information about the extracted facility as the response 55 to an output device for the utterer. This allows effective use of output resources (e.g., a display space of a display or a time period for voice output) at the time of outputting the response 55 to the output device for the utterer.

Note that attribute information indicating an attribute of a passenger may be obtained by an arbitrary method. The attribute information indicating the attribute of the passenger may be managed as profile information associated with information for identification of the passenger. The attribute information may be managed in the same profile information as one for information as described above indicating a transmission destination or managed in profile information different from that for the information indicating the transmission destination. In either case, the attribute information can be treated in the same manner except that a management form is different. For this reason, information indicating a transmission destination and attribute information will be treated as being managed in the same profile information (i.e., the profile information includes the information indicating the transmission destination and the attribute information) below for convenience of description. A description of a mode in which information indicating a transmission destination and attribute information are separately managed will be properly omitted.

In one example, the vehicle-mounted apparatus 1 may identify individuality of an utterer in a process of identifying an utterer, as in the method described above for identifying a transmission destination. The vehicle-mounted apparatus 1 may obtain profile information of the utterer in accordance with a result of identifying the individuality of the utterer. The vehicle-mounted apparatus 1 may identify an attribute of the utterer by referring to the obtained profile information. The vehicle-mounted apparatus 1 may optimize the response 55 such that the response 55 is suited to the identified attribute.

In the above-described specific example, the vehicle-mounted apparatus 1 may generate a candidate for the response 55 by extracting a facility present in the surroundings of the vehicle V at the time of the inquiry 50 from the database on facility information. The vehicle-mounted apparatus 1 may generate the optimized response 55 by further extracting a facility suited to the attribute of the utterer among generated candidates for the response 55. The vehicle-mounted apparatus 1 may output the optimized response 55 to the output device for the utterer.

When facility information is held in a different computer, the vehicle-mounted apparatus 1 may cause a different computer to execute the optimization process. At least a part of the process of optimizing the response 55 may be executed as a computation process of a trained machine learning model. In one example, the machine learning model may be trained by machine learning so as to acquire the capability to accept input of an inquiry and attribute information of an utterer and generate a proper response in response to the input inquiry and attribute information. The vehicle-mounted apparatus 1 or the different computer may use the trained machine learning model to generate the response 55 optimized for an attribute of the utterer.

Note that the response 55 need not be limited to the above-descried examples. In another example, the optimization process described above may be skipped, and the response 55 may be uniformly generated irrespective of an attribute of an utterer. Whether or not to optimize the response 55 may be determined in accordance with whether the utterer is a driver PA or the fellow passenger PZ and in accordance with the attribute of the utterer. In one example, the driver PA may desire to thoroughly obtain, as the response 55, pieces of information which may be associated with the inquiry 50. For this reason, when the utterer is the fellow passenger PZ, the vehicle-mounted apparatus 1 according to the present embodiment may optimize the response 55 in accordance with the attribute of the fellow passenger PZ and output the optimized response 55 to an output device for the fellow passenger PZ. On the other hand, when the utterer is the driver PA, the vehicle-mounted apparatus 1 may skip an optimization process appropriate to the attribute of the utterer (driver PA) and output the generated response 55 to an output device for the driver PA.

(Profile Information)

Profile information may be held in an arbitrary data format in an arbitrary storage region. The profile information may be managed on a database. The profile information may be held in at least one of the memory resources of the vehicle-mounted apparatus 1 and an external server 7.

The external server 7 may be composed of one or more server apparatuses. The server apparatuses constituting the external server 7 may share at least a part in common with the server apparatuses constituting the external server 6. A server apparatus which holds information indicating a transmission destination and a server apparatus which holds attribute information may be different or may at least partially coincide with each other.

When profile information is held in the external server 7, the vehicle-mounted apparatus 1 may be configured to be capable of connecting to the external server 7 via a network. The profile information may be used for at least one of generation of the response 55 and identification of a transmission destination, and the vehicle-mounted apparatus 1 may be configured to cause the external server 6 to transmit the response 55 as the process of outputting the response 55. In this case, the profile information may be provided from the external server 7 to the external server 6 in accordance with directions from the vehicle-mounted apparatus 1.

An apparatus which holds profile information may be the same for both a driver PA and a fellow passenger PZ or may be different between the driver PA and the fellow passenger PZ. In one example, pieces of profile information for the driver PA and the fellow passenger PZ may be held in the vehicle-mounted apparatus 1 or the external server 7. In another example, the profile information for the driver PA may be stored in the vehicle-mounted apparatus 1 or a terminal (e.g., an electronic key or a mobile terminal) of the driver PA. The profile information for the fellow passenger PZ may be stored in the external server 7 or the terminal 37 of the fellow passenger PZ.

### 2 Configuration Example

### Hardware Configuration Example

FIG. 2 schematically illustrates an example of a hardware configuration of the vehicle-mounted apparatus 1 according to the present embodiment. As illustrated in FIG. 2, the vehicle-mounted apparatus 1 according to the present embodiment is a computer in which a controller 11, a storage unit 12, an input device 13, an output device 14, a drive 15, and a communication interface 16 are electrically connected.

The controller 11 includes a CPU (Central Processing Unit) that is a hardware processor, a RAM (Random Access Memory), a ROM (Read Only Memory), and the like and is configured to execute an information process on the basis of a program and various types of data. The controller 11 (CPU) is an example of processor resources.

The storage unit 12 is composed of, for example, a hard disk drive, a solid state drive, or the like. The storage unit 12 is an example of the memory resources. In the present embodiment, the storage unit 12 stores various types of information, such as a program 81. The program 81 is a program for causing the vehicle-mounted apparatus 1 to execute the information process (FIG. 4 to be described later) of outputting the response 55 to the utterance-based inquiry 50 from a passenger. The program 81 includes a sequence of instructions from the information process.

The input device 13 is a device for inputting, such as a manipulation button or a microphone. The output device 14 is a device for producing an output, such as a display or a speaker. A passenger can manipulate the vehicle-mounted apparatus 1 by using the input device 13 and the output device 14. The input device 13 and the output device 14 may be integrally constructed as, for example, a touch panel display. In the present embodiment, the input device 13 may include the microphone 20. The output device 14 may include the vehicle-mounted display 30 for a driver PA and one or more vehicle-mounted displays 35 for a fellow passenger (fellow passengers) PZ.

The drive 15 is a device for loading various types of information, such as a program stored in a storage medium 91. The program 81 may be stored in the storage medium 91. The storage medium 91 is a medium in which various types of information, such as a stored program, are accumulated by electrical, magnetic, optical, mechanical, or chemical action such that a computer, an apparatus, a machine, or the like can read information, such as the program. The vehicle-mounted apparatus 1 may obtain the program 81 from the storage medium 91. Similarly, at least either of facility information and profile information as described above may be stored in the storage medium 91. The vehicle-mounted apparatus 1 may obtain at least either of the facility information and the profile information from the storage medium 91.

In FIG. 2, a disk-type storage medium, such as a CD or DVD, is illustrated as an example of the storage medium 91. However, the type of the storage medium 91 is not limited to a disk type and may be one other than the disk type. As a storage medium of a type other than the disk type, a semiconductor memory, such as a flash memory, can be named. The type of the drive 15 may be properly selected in accordance with the type of the storage medium 91.

The communication interface 16 is, for example, a wireless LAN (Local Area Network) module and is configured to perform data communication via a network. The vehicle-mounted apparatus 1 may use the communication interface 16 to perform data communication with a different computer (e.g., each external server (6 or 7) or the terminal 37 of a fellow passenger PZ). The vehicle-mounted apparatus 1 may include a plurality of types of communication interfaces 16. Accordingly, the vehicle-mounted apparatus 1 may be configured to be capable of executing data communication by a plurality of communication methods different from each other.

Note that, as for the specific hardware configuration of the vehicle-mounted apparatus 1, a component can be properly omitted, replaced, and added in accordance with an embodiment. For example, the controller 11 may include a plurality of hardware processors. The hardware processors may be composed of a microprocessor, an ECU (Electronic Control Unit), an FPGA (field-programmable gate array), a GPU (Graphics Processing Unit), and the like. At least any of the input device 13, the output device 14, the drive 15, and the communication interface 16 may be omitted.

The vehicle-mounted apparatus 1 may further include an external interface for interfacing to an external apparatus. The external interface is, for example, a USB (Universal Serial Bus) port, a dedicated port, or the like. The types and the number of external interfaces may be properly determined in accordance with the types and the number of external apparatuses to be connected. At least either of the vehicle-mounted displays (30 and 35) and the terminal 37 of the fellow passenger PZ may be connected to the vehicle-mounted apparatus 1 via the external interface.

The vehicle-mounted apparatus 1 may be composed of a plurality of computers. In this case, hardware configurations of the computers may or may not coincide with each other. The vehicle-mounted apparatus 1 may be an arbitrary computer that is at least temporarily mounted on the vehicle V and executes an information process. The vehicle-mounted apparatus 1 may be a general-purpose computer, a cellular phone which may be a smartphone, a tablet PC, or the like in addition to a computer designed specifically for a service to be provided.

### Software Configuration Example

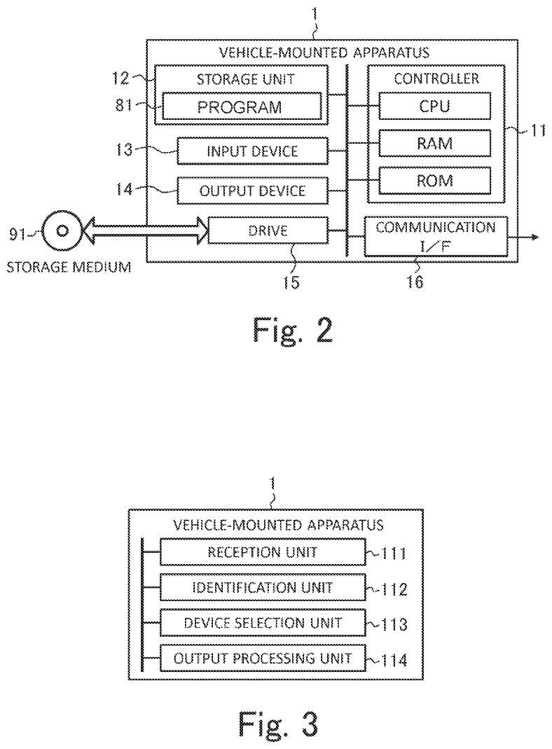

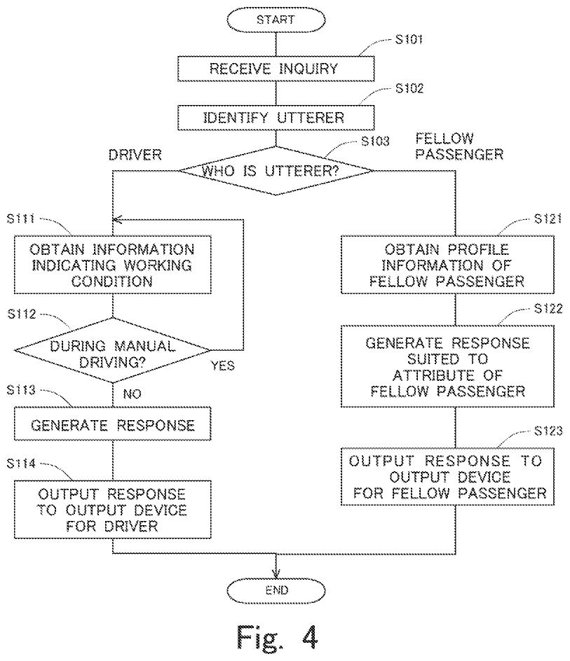

FIG. 3 schematically illustrates an example of a software configuration of the vehicle-mounted apparatus 1 according to the present embodiment. The controller 11 of the vehicle-mounted apparatus 1 loads the program 81 stored in the storage unit 12 into the RAM. The controller 11 executes instructions included in the program 81 that is loaded into the RAM by the CPU. With this configuration, the vehicle-mounted apparatus 1 according to the present embodiment works as a computer including, as software modules, a reception unit 111, an identification unit 112, a device selection unit 113, and an output processing unit 114, as illustrated in FIG. 3. That is, in the present embodiment, the software modules of the vehicle-mounted apparatus 1 are implemented by the controller 11 (CPU).

The reception unit 111 is configured to accept the utterance-based inquiry 50 of a passenger in the vehicle V. The identification unit 112 is configured to identify the passenger that has uttered the received inquiry 50. The device selection unit 113 is configured to select an output device serving as a destination to which the response 55 to the inquiry 50 is to be output in accordance with a result of the identification of the passenger. The output processing unit 114 is configured to output the response 55 to the inquiry 50 to the selected output device.

Note that an example where every software module of the vehicle-mounted apparatus 1 is implemented by a general-purpose CPU is described in the present embodiment. However, some or all of the software modules may be implemented by one or a plurality of dedicated processors. Each of the modules may be implemented as a hardware module. As for the software configuration of the vehicle-mounted apparatus 1, a module may be properly omitted, replaced, and added in accordance with an embodiment.

### 3 Working Example

FIG. 4 is a flowchart illustrating an example of a procedure of the vehicle-mounted apparatus 1 according to the present embodiment. The processing procedure to be described below is an example of an information processing method according to an aspect of the present disclosure. Note that the processing procedure to be described below is merely illustrative and that steps may be changed as much as possible. As for the processing procedure to be described below, a step may be properly omitted, replaced, and added in accordance with an embodiment.

(Step S101)

In step S101, the controller 11 works as the reception unit 111 and receives the utterance-based inquiry 50 of a passenger in the vehicle V.

Types of the inquiry 50 may be properly selected in accordance with an embodiment. In one example, the inquiry 50 may be about a facility present in the surroundings of the vehicle V. Utterance content corresponding to each type of the inquiry 50 need not be particularly limited and may be properly determined in accordance with an embodiment. In one example, an utterance, such as “What is that?” or “Tell me facilities around here,” may correspond to an inquiry about a facility present around the vehicle V.

The inquiry 50 may be received by an arbitrary method. In the present embodiment, the controller 11 may receive the inquiry 50 by the microphone 20. A data format of the received inquiry 50 may be properly selected in accordance with an embodiment. In one example, the inquiry 50 may be obtained as voice data. Voice data of the inquiry 50 may be converted into text data by being analyzed. When the controller 11 receives the utterance-based inquiry 50, the controller 11 advances the process to next step S102.

(Step S102)

In step S102, the controller 11 works as the identification unit 112 and identifies the passenger that is an utterer of the received inquiry 50.

A method for identifying the utterer may be properly selected in accordance with an embodiment. In one example, the microphone 20 may have directivity, and the controller 11 may identify the utterer on the basis of an utterance sound collection direction. In another example, the vehicle V may include a vehicle-mounted camera, and the controller 11 may identify the utterer by analyzing a picked-up image that is obtained by the vehicle-mounted camera. In the present embodiment, the controller 11 may identify individuality of the utterer by a method, such as voiceprint analysis or facial image analysis, in the process of identifying the utterer.

A trained machine learning model (identification model) that is generated by machine learning may be used to identify the utterer. In one example, the identification model may be properly trained by machine learning so as to acquire the capability to identify an utterer from input data, such as voice data of an inquiry or a picked-up image. In this case, the controller 11 may give input data (e.g., voice data of the inquiry 50 or a picked-up image) obtained at the time of utterance of the inquiry 50 to the trained identification model and execute a computation process of the trained identification model. The computation process of the identification model is, for example, a feedforward computation process of a neural network. As a result of executing the computation process, the controller 11 may obtain an output corresponding to a result of identifying the utterer from the trained identification model. When the controller 11 identifies the utterer, the controller 11 advances the process to next step S103.

(Step S103)

In step S103, the controller 11 works as the device selection unit 113 and selects, in accordance with a result of the identification of the passenger that is the utterer, an output device serving as a destination to which the response 55 to the inquiry 50 is to be output.

When the controller 11 identifies the utterer as a driver PA, the controller 11 selects an output device for the driver PA as the output destination. In the present embodiment, the controller 11 may select the vehicle-mounted display 30 arranged for the driver PA as the output device for the driver PA serving as the destination to which the response 55 is to be output.

On the other hand, when the controller 11 identifies the utterer as a fellow passenger PZ, the controller 11 selects an output device for the fellow passenger PZ as the output destination. In the present embodiment, the controller 11 may select the vehicle-mounted display 35 or the terminal 37 of the fellow passenger PZ as the output device for the fellow passenger PZ serving as the destination to which the response 55 is to be output.

The controller 11 determines a branch destination of the process in accordance with a result of selecting the output device. When the controller 11 selects the output device for the driver PA as the output destination of the response 55, the controller 11 advances the process to step S111. On the other hand, when the controller 11 selects the output device for the fellow passenger PZ as the output destination of the response 55, the controller 11 advances the process to step S121.

Note that the response 55 may be output at an arbitrary timing after the reception of the inquiry 50. In the one example in FIG. 4, the vehicle-mounted apparatus 1 adopts a mode of promptly executing the output process when the utterer is the fellow passenger PZ and outputting the response 55 while manual running of the vehicle V is not being performed when the utter is the driver PA.

The response 55 may be properly generated in response to the inquiry 50. The response 55 may be optimized in accordance with an attribute of the utterer. In one example, the response 55 may be constructed from facility information about a facility present in the surroundings of the vehicle V at the time of the inquiry 50. When the optimization is performed, the facility information, from which the response 55 is constructed, may be about a facility suited to the attribute of the passenger that is the utterer of the inquiry 50 among a plurality of facilities present in the surroundings of the vehicle V at the time of the inquiry 50. In the one example in FIG. 4, the vehicle-mounted apparatus 1 adopts a mode of optimizing the response 55 in accordance with an attribute of the fellow passenger PZ when the utterer is the fellow passenger PZ and skipping the optimization process when the utterer is the driver PA.

(Step S111 to Step S114)

In step S111 to step S114, the controller 11 works as the output processing unit 114 and executes the output process for outputting the response 55 to the inquiry 50 to the output device for the selected utterer (driver PA).

In step S111, the controller 11 obtains information indicating the working condition of the vehicle V. The working condition of the vehicle V may include conditions, such as whether or not the vehicle V is running, and the on/off state of automated driving. A vehicle-mounted sensor may be used to monitor the working condition of the vehicle V. The controller 11 may obtain the information indicating the working condition of the vehicle V from the vehicle-mounted sensor. In one example, the vehicle-mounted sensor may be directly connected to the vehicle-mounted apparatus 1. In another example, the vehicle-mounted sensor may be connected to a different computer. In this case, the controller 11 may obtain the information indicating the working condition of the vehicle V via the different computer. When the controller 11 obtains the information indicating the working condition of the vehicle V, the controller 11 advances the process to next step S112.

In step S112, the controller 11 judges on the basis of the obtained information whether or not manual running (manual driving) of the vehicle V is being performed. The controller 11 determines a branch destination of the process in accordance with a result of the judgment. When the controller 11 judges that manual driving is not being performed, the controller 11 advances the process to next step S113. On the other hand, when the controller 11 judges that manual driving is being performed, the controller 11 returns the process to step S111 and executes the processes in step S111 and step S112 again. In this manner, the controller 11 repeatedly monitors the working condition of the vehicle V until it is judged that manual driving is not being performed.

In step S113, the controller 11 generates the response 55 to the inquiry 50. The response 55 may be generated by an arbitrary information process. In one example, the controller 11 may obtain the position information of the vehicle V in accordance with the fact that the inquiry 50 is about a facility present in the surroundings of the vehicle V. The controller 11 may obtain facility information about a facility present in the surroundings of the vehicle V by searching a database on the basis of the position indicated by the position information.

In one example, a database on facility information may be stored in the storage unit 12 or the storage medium 91. In this case, the controller 11 may obtain facility information from the storage unit 12 or the storage medium 91. In another example, the database on facility information may be stored in the external server 6. In this case, the controller 11 may obtain facility information from the external server 6 by accessing the external server 6 via a network. The controller 11 may construct the response 55 from the obtained facility information.

A trained machine learning model generated by machine learning may be used to generate the response 55. In one example, the controller 11 may give data of the inquiry 50 to the trained machine learning model and execute a computation process of the trained machine learning model. To obtain facility information as the response 55, the controller 11 may further give the position information to the trained machine learning model. As a result of executing the computation process, the controller 11 may obtain an output corresponding to information about the response 55 from the trained machine learning model. When the controller 11 generates the response 55, the controller 11 advances the process to next step S114.

In step S114, the controller 11 outputs the generated response 55 to the output device for the driver PA. When the controller 11 selects the vehicle-mounted display 30 as the output destination in the process in step S103, the controller 11 outputs the generated response 55 to the vehicle-mounted display 30. In one example, the output device for the driver PA may be directly connected to the vehicle-mounted apparatus 1. In this case, the controller 11 may directly output the generated response 55 to the output device. In another example, the output device for the driver PA may be connected to a network. In this case, the controller 11 may transmit the generated response 55 to the output device via the network.

To transmit the response 55 via the network, the controller 11 may obtain information indicating a transmission destination of the output device for the driver PA by an arbitrary method. In one example, the controller 11 may obtain profile information (the information indicating the transmission destination) of the driver PA in accordance with the result of the identification in the process in step S102. The profile information may be stored in at least any of the storage unit 12, the storage medium 91, and the external server 7. The controller 11 may obtain the profile information of the driver PA from the storage unit 12, the storage medium 91, or the external server 7. The controller 11 may identify the transmission destination of the output device for the driver PA by referring to the obtained profile information. The controller 11 may transmit the response 55 to the identified transmission destination.

Note that the controller 11 may cause a different computer, such as the external server 6, to execute the processes in step S113 and step S114. In one example, in step S113, the controller 11 may transmit obtained position information to the external server 6 and cause the external server 6 to generate the response 55 (facility information). In step S114, the controller 11 may cause the external server 6 to transmit the generated response 55 (facility information) to the output device for the driver PA. When the vehicle-mounted apparatus 1 holds the profile information of the driver PA, the controller 11 may provide at least information indicating the transmission destination of the output device for the driver PA of the profile information to the external server 6. When the profile information of the driver PA is held in the external server 7, and the external server 7 is independent of the external server 6, the controller 11 may cause the external server 7 to provide at least the information indicating the transmission destination of the output device for the driver PA of the profile information to the external server 6. In this manner, the controller 11 may cause the external server 6 to transmit facility information to the transmission destination for the driver PA identified from the profile information.

The controller 11 may also monitor at least one of an elapsed time period since the reception of the inquiry 50 in the process in step S101 and the running distance of the vehicle V. The controller 11 determines whether or not at least one of the elapsed time period and the running distance has exceeded a corresponding threshold. The series of monitoring processes may be executed at an arbitrary timing before execution of the process in step S114. When the elapsed time period and the running distance have not exceeded corresponding thresholds, the controller 11 may execute the process in step S114. On the other hand, when at least one of the elapsed time period and the running distance has exceeded the corresponding threshold, the controller 11 may discard the response 55 to the inquiry 50 and skip at least execution of the process in step S114. When at least one of the elapsed time period and the running distance has exceeded the corresponding threshold while the processes in step S111 and step S112 are being executed, the controller 11 may skip execution of the process in step S113.

When the controller 11 outputs the response 55 to the output device for the driver PA, the controller 11 ends the processing procedure according to the present working example.

(Step S121 to Step S123)

In step S121 to step S123, the controller 11 works as the output processing unit 114 and executes the output process for outputting the response 55 to the inquiry 50 to the output device for the selected utterer (fellow passenger PZ).

In step S121, the controller 11 obtains profile information (attribute information) of the fellow passenger PZ in accordance with the result of the identification in the process in step S102. In step S122, the controller 11 refers to the obtained profile information and identifies an attribute of the fellow passenger PZ. The controller 11 generates the response 55 (i.e., the optimized response 55) suited to the identified attribute. In one example, the controller 11 may generate, as the optimized response 55, facility information about a facility suited to the attribute of the fellow passenger PZ among a plurality of facilities present in the surroundings of the vehicle V at the time of the inquiry 50. In step S123, the controller 11 outputs the generated response 55 to the output device for the fellow passenger PZ. When the controller 11 selects the vehicle-mounted display 35 or the terminal 37 of the fellow passenger PZ as the output destination in the process in step S103, the controller 11 outputs the generated response 55 to the vehicle-mounted display 35 or the terminal 37 of the fellow passenger PZ.

The processes in step S121 to step S123 may be the same as the processes in step S113 and step S114 described above except that the output destination is the output device for the fellow passenger PZ and that the response 55 is optimized in accordance with the attribute of the fellow passenger PZ in the processes in step S121 and step S122. That is, in the process in step S121, the profile information (attribute information and information indicating a transmission destination) may be obtained from the storage unit 12, the storage medium 91, or the external server 7. In the process in step S123, in one example, the controller 11 may directly output the generated response 55 to the output device for the fellow passenger PZ. In another example, the controller 11 may transmit the generated response 55 to the output device for the fellow passenger PZ via a network. In this case, the controller 11 may identify the transmission destination of the output device for the fellow passenger PZ by referring to the profile information (the information indicating the transmission destination).

In step S122, the optimization of the response 55 may be achieved by an arbitrary information process. In one example, the controller 11 may obtain the position information of the vehicle V in accordance with the fact that the inquiry 50 is about a facility present in the surroundings of the vehicle V. The controller 11 may obtain facility information about a facility suited to the attribute of the fellow passenger PZ among facilities present in the surroundings of the vehicle V by searching a database using a query based on the position information of the vehicle V and the attribute of the fellow passenger PZ. When the database is stored in the storage unit 12 or the storage medium 91, the controller 11 may obtain facility information from the storage unit 12 or the storage medium 91. When the database is stored in the external server 6, the controller 11 may obtain facility information from the external server 6 by accessing the external server 6 via a network. In step S123, the controller 11 may output the obtained facility information as the optimized response 55 to the output device for the fellow passenger PZ.

A trained machine learning model generated by machine learning may be used to optimize the response 55. In one example, the trained machine learning model may have the capability to perform generation and optimization of the response 55. The controller 11 may give the data of the inquiry 50 and the attribute information of the utterer to the trained machine learning model and execute a computation process of the trained machine learning model. To obtain facility information as the response 55, the controller 11 may further give the position information to the trained machine learning model. As a result of executing the computation process, the controller 11 may obtain an output corresponding to information about the optimized response 55 from the trained machine learning model.

Note that the controller 11 may cause a different computer, such as the external server 6, to execute the processes in at least step S122 and step S123 among step S121 to step S123. In one example, in step S122, the controller 11 may transmit the position information and the attribute information to the external server 6 and cause the external server 6 to generate the response 55 (facility information) suited to the attribute of the fellow passenger PZ. In step S123, the controller 11 may cause the external server 6 to transmit the generated response 55 (facility information) to the output device for the fellow passenger PZ.

When the vehicle-mounted apparatus 1 holds the profile information of the fellow passenger PZ, the controller 11 may provide at least the attribute information of the fellow passenger PZ and the information indicating the transmission destination of the profile information to the external server 6. When the profile information of the fellow passenger PZ is held in the external server 7, and the external server 7 is independent of the external server 6, the controller 11 may cause the external server 7 to provide at least the attribute information of the fellow passenger PZ and the information indicating the transmission destination of the profile information to the external server 6. One of the attribute information of the fellow passenger PZ and the information indicating the transmission destination may be provided from the vehicle-mounted apparatus 1, and the other may be provided from the external server 7. In this manner, the controller 11 may cause the external server 6 to extract facility information suited to the attribute of the fellow passenger PZ and transmit the obtained facility information to the output device for the fellow passenger PZ.

When the controller 11 outputs the response 55 to the output device for the fellow passenger PZ, the controller 11 ends the processing procedure according to the present working example.

Note that, after execution of the process in step S114 or step S123, the controller 11 may return the process to step S101 and wait until the controller 11 receives the new inquiry 50. After reception of the new inquiry 50 as the process in step S101, the controller 11 may execute the processes in step S102 and subsequent processes for the new inquiry 50. With this configuration, the controller 11 may repeatedly execute the processes starting from step S101. In one example, the controller 11 may continuously repeat execution of the series of information processes starting from step S101 until the controller 11 is directed by a passenger to stop execution of an information process of outputting the response 55 to the inquiry 50. For this reason, the vehicle-mounted apparatus 1 may be configured to continuously execute the information process of outputting the response 55 to the inquiry 50 from a passenger.

[Feature]

The vehicle-mounted apparatus 1 according to the present embodiment controls an output destination of the response 55 to the inquiry 50 in accordance with a result of identifying an utterer in the processes in step S102 and step S103. This makes it possible to output the response 55 to a suitable output device for each passenger (the driver PA or the fellow passenger PZ) in the processes in step S114 and step S123. Thus, according to the present embodiment, accessibility to the response 55 to the inquiry 50 from a passenger can be enhanced.

### 4 Modifications

Although the embodiment of the present disclosure has been described above in detail, the above description is merely illustrative of the present disclosure in all respects. It will be obvious that various improvements or modifications can be made without departing from the scope of the present disclosure. For example, changes as described below may be made. The modifications below can be properly combined.

In the processing procedure according to the embodiment, the processes of generating the response 55 in step S113 and step S122 may be executed at arbitrary timings after step S101. When the response 55 to be generated is changed (optimized in the embodiment) in accordance with a passenger, as in the embodiment, the processes in step S113 and step S122 may be executed at arbitrary timings after step S102.

As for the output process for the driver PA, the processes in step S111 and step S112 described above may be skipped. In the process in step S113, the controller 11 may generate the response 55 suited to the attribute of the driver PA, as in the processes in step S121 and step S122. In this case, the profile information (attribute information) of the driver PA may be obtained from the storage unit 12, the storage medium 91, or the external server 7. To cause the external server 6 to generate the response 55 (facility information) suited to the attribute of the driver PA, at least the attribute information of the profile information of the driver PA may be provided from the vehicle-mounted apparatus 1 or the external server 7 to the external server 6.

To skip the process of identifying a transmission destination using profile information, information indicating the transmission destination may be omitted from the profile information. To skip the process of optimizing the response 55 in accordance with an attribute of an utterer using profile information, attribute information may be omitted from profile information. To skip both the process of identifying a transmission destination and the process of optimizing the response 55, a configuration related to profile information may be omitted. In this case, in the process in step S102, the process of identifying individuality of an utterer may be skipped. When profile information is not used, the process in step S121 may be skipped in the output process for the fellow passenger PZ. When a mode of optimizing the response 55 is not adopted, the response 55 may be generated by the same method as step S113 in the process in step S122.

Additionally, when the processes starting from step S101 are repeatedly executed in the processing procedure according to the embodiment, the controller 11 may hold referred-to profile information in the memory resources (e.g., the RAM). In a repetitive process after that, the controller 11 may skip the process of obtaining profile information.

### 5 Supplement

The processes and structure described in the present disclosure can be freely combined and implemented unless a technical contradiction arises.

A process described as being performed by one apparatus may be shared and executed by a plurality of apparatuses. Alternatively, a process described as being performed by different apparatuses may be executed by one apparatus. In a computer system, by which type of hardware configuration functions are to be implemented is flexibly changeable.

The present disclosure can also be implemented by supplying a computer program provided with the functions described in the above embodiment to a computer and reading out and executing, by one or more processors which the computer has, the program. Such a computer program may be provided to the computer as a non-transitory computer-readable storage medium that is connectable to a system bus of the computer or may be provided to the computer over a network. Examples of the non-transitory computer-readable storage medium include any type of disk, such as a magnetic disk (e.g., a Floppy® disk or a hard disk drive (HDD)) or an optical disc (e.g., a CD-ROM, a DVD, or a Blu-ray Disc), a read-only memory (ROM), a random access memory (RAM), an EPROM, an EEPROM, a magnetic card, a flash memory, an optical card, and any type of medium suitable for storing electronic instructions.

What is claimed is:

1. A vehicle-mounted apparatus comprising
a controller configured to execute:
receiving an utterance-based inquiry of a passenger in a vehicle;
identifying the passenger that is an utterer of the received inquiry;
selecting, in accordance with a result of the identification of the passenger, an output device serving as a destination to which a response to the inquiry is to be output; and
outputting the response to the inquiry to the selected output device.

2. The vehicle-mounted apparatus according to claim 1, wherein
the selecting the output device in accordance with the result of the identification comprises selecting a vehicle-mounted display arranged for a seat for a fellow passenger or a terminal of the fellow passenger as the output device serving as the destination to which the response is to be output, when the passenger that is the utterer of the inquiry is the fellow passenger.

3. The vehicle-mounted apparatus according to claim 1, wherein
the selecting the output device in accordance with the result of the identification comprises selecting a vehicle-mounted display arranged for a driver as the output device serving as the destination to which the response is to be output, when the passenger that is the utterer of the inquiry is the driver.

4. The vehicle-mounted apparatus according to claim 1, wherein
the controller is configured to further execute judging whether or not manual running of the vehicle is being performed when the passenger that is the utterer of the inquiry is a driver, and
when the passenger that is the utterer of the inquiry is the driver, the outputting the response to the inquiry is executed after it is judged that manual running of the vehicle is not being performed.

5. The vehicle-mounted apparatus according to claim 1, wherein
the inquiry is about a facility present in surroundings of the vehicle, and
the response is constructed from facility information about the facility present in the surroundings of the vehicle at the time of the inquiry.

6. The vehicle-mounted apparatus according to claim 5, wherein
the outputting the response to the inquiry is composed of
obtaining the facility information from an external server, and outputting the obtained facility information to the output device, or
causing the external server to transmit the facility information to the output device.

7. The vehicle-mounted apparatus according to claim 5, wherein
the facility information is about a facility suited to an attribute of the passenger that is the utterer of the inquiry among a plurality of facilities present in the surroundings of the vehicle at the time of the inquiry.

8. An information processing method to be executed by a computer, comprising:
receiving an utterance-based inquiry of a passenger in a vehicle;
identifying the passenger that is an utterer of the received inquiry;
selecting, in accordance with a result of the identification of the passenger, an output device serving as a destination to which a response to the inquiry is to be output; and
outputting the response to the inquiry to the selected output device.

9. The information processing method according to claim 8, wherein
the selecting the output device in accordance with the result of the identification comprises selecting a vehicle-mounted display arranged for a seat for a fellow passenger or a terminal of the fellow passenger as the output device serving as the destination to which the response is to be output, when the passenger that is the utterer of the inquiry is the fellow passenger.

10. The information processing method according to claim 8, wherein
the selecting the output device in accordance with the result of the identification comprises selecting a vehicle-mounted display arranged for a driver as the output device serving as the destination to which the response is to be output, when the passenger that is the utterer of the inquiry is the driver.

11. The information processing method according to claim 8, further comprising
judging whether or not manual running of the vehicle is being performed when the passenger that is the utterer of the inquiry is the driver,
wherein, when the passenger that is the utterer of the inquiry is the driver, the outputting the response to the inquiry is executed after it is judged that manual running of the vehicle is not being performed.

12. The information processing method according to claim 8, wherein
the inquiry is about a facility present in surroundings of the vehicle, and
the response is constructed from facility information about the facility present in the surroundings of the vehicle at the time of the inquiry.

13. The information processing method according to claim 12, wherein
the outputting the response to the inquiry is composed of obtaining the facility information from an external server, and outputting the obtained facility information to the output device, or
causing the external server to transmit the facility information to the output device.

14. The information processing method according to claim 12, wherein
the facility information is about a facility suited to an attribute of the passenger that is the utterer of the inquiry among a plurality of facilities present in the surroundings of the vehicle at the time of the inquiry.

15. A non-transitory storage medium storing a program for causing a computer to execute an information processing method, the information processing method comprising:
receiving an utterance-based inquiry of a passenger in a vehicle;
identifying the passenger that is an utterer of the received inquiry;
selecting, in accordance with a result of the identification of the passenger, an output device serving as a destination to which a response to the inquiry is to be output; and
outputting the response to the inquiry to the selected output device.

16. The non-transitory storage medium according to claim 15, wherein
the selecting the output device in accordance with the result of the identification comprises selecting a vehicle-mounted display arranged for a seat for a fellow passenger or a terminal of the fellow passenger as the output device serving as the destination to which the response is to be output, when the passenger that is the utterer of the inquiry is the fellow passenger.

17. The non-transitory storage medium according to claim 15, wherein
the selecting the output device in accordance with the result of the identification comprises selecting a vehicle-mounted display arranged for a driver as the output device serving as the destination to which the response is to be output, when the passenger that is the utterer of the inquiry is the driver.

18. The non-transitory storage medium according to claim 15, wherein
the information processing method further comprises judging whether or not manual running of the vehicle is being performed when the passenger that is the utterer of the inquiry is the driver, and
when the passenger that is the utterer of the inquiry is the driver, the outputting the response to the inquiry is executed after it is judged that manual running of the vehicle is not being performed.

19. The non-transitory storage medium according to claim 15, wherein
the inquiry is about a facility present in surroundings of the vehicle, and
the response is constructed from facility information about the facility present in the surroundings of the vehicle at the time of the inquiry.

20. The non-transitory storage medium according to claim 19, wherein
the outputting the response to the inquiry is composed of
obtaining the facility information from an external server, and outputting the obtained facility information to the output device, or
causing the external server to transmit the facility information to the output device.
